(19) United States
(12) Patent Application Publication
(10) Pub. No.: US 2025/0085200 A1
(43) Pub. Date: Mar. 13, 2025

(54) Tissue Cutting Assembly And Associated Method Of Use

(71) Applicants: Joseph Richard Cant, Naples, FL (US); Gary Michael Wilson, Naples, FL (US)

(72) Inventors: Joseph Richard Cant, Naples, FL (US); Gary Michael Wilson, Naples, FL (US)

(21) Appl. No.: 18/828,589

(22) Filed: Sep. 9, 2024

Related U.S. Application Data
(60) Provisional application No. 63/582,096, filed on Sep. 12, 2023.

(51) Int. Cl. G01N 1/28; G01N 1/36

(52) U.S. Cl. CPC G01N 1/286; G01N 1/36; G01N 2001/2873

(57) ABSTRACT

A tissue cutting assembly used for cutting tissue samples from a tissue sample includes a substrate configured to receive the tissue sample thereon, a frame defining an opening through which the tissue sample is exposed, and a tissue cutting guide positioned and held stationary within the opening in at least two distinct positions onto the tissue sample. The tissue cutting guide defines one or more cutting slits through which a user can insert and guide a cutting device to cut the tissue sample along a length corresponding to the length of the one or more slits in each of the at least two distinct positions to form cut tissue samples of desired widths and lengths.

### CROSS-REFERENCE TO RELATED APPLICATIONS

The subject disclosure claims priority from and the benefit of U.S. Provisional Patent Application No. 63/582,096, filed Sep. 12, 2023, the disclosure of which is incorporated by reference in its entirety herein.

### BACKGROUND OF THE DISCLOSURE

### 1. Field of the Disclosure

The subject disclosure relates generally to tissue cutting devices and their associated uses in cutting tissue samples.

### 2. Description of the Related Art

Tissue processing laboratories typically ‘section’ tissue, like stem-cell rich amniotic sacs, into various sized squares or rectangles to be applied to surgical wounds to promote healing.

Different surgeries require different sized and shaped tissue samples, such as tissue rectangles or squares. Typically, laboratory technicians had to use straight-edge rulers to measure and guide a scalpel for each cut, which is time consuming to cut each tissue sample to a desired shape one at a time and are often not precise in measurements.

The subject disclosure provides a solution to prepare tissue samples that addresses many of the concerns identified above with respect to the use of straight-edge rulers and scalpels.

### SUMMARY OF THE DISCLOSURE

The subject disclosure provides a tissue cutting assembly, and an associated method of use of the tissue cutting assembly for use in preparing tissue samples of a desired size and shape from a tissue sample.

The tissue cutting assembly includes a substrate configured to receive a tissue sample thereon. The tissue cutting assembly also includes a frame secured to the substrate having an internal perimeter defining an opening and a tissue cutting guide having an external perimeter complimentary in configuration to the internal perimeter of the frame, with the tissue cutting guide defining a plurality of spaced apart slits extending therethrough. The tissue cutting guide is positionable within the opening of the frame in any one of a plurality of positions relative to the frame. Once placed in any one of the plurality of positions, the external perimeter of the tissue cutting guide at least partially abuts the internal perimeter of the frame to prevent rotational movement of the tissue cutting guide relative to the frame and the substrate for allowing a user to apply desired cuts to the tissue sample through the spaced apart slits.

The associated method of preparing tissue samples includes the steps of:
disposing the tissue sample on the substrate;
disposing the frame on the substrate such that the tissue sample is held stationary by the frame and such that a portion of the tissue sample is visible and accessible through the opening;
securing the frame to the substrate;
disposing the tissue cutting guide within the opening of the frame in any one of a plurality of positions relative to the frame, wherein the external perimeter of the tissue cutting guide at least partially abuts the internal perimeter of the frame to prevent rotational movement of the tissue cutting guide relative to the frame and the substrate; and
allowing a user to apply desired cuts to the tissue sample through the spaced apart slits.

This disclosure eliminates the need for a straight-edge ruler used to cut tissue samples and allows for a consistent, repeatable method for cutting tissue samples of desired lengths, widths, or shapes. Still further, by providing the tissue cutting guide with an external perimeter complimentary in configuration to the internal perimeter of the frame, and by preventing the rotation of the tissue cutting guide after disposition of the tissue cutting guide within the frame due to the partially abutment of the tissue cutting guide with the internal perimeter of the frame, the elimination or minimization of misshapen tissue samples associated with the movement of the tissue cutting guide during a cutting operation can be achieved, saving time and effort in preparing tissue samples. In addition, the multiple cutting guide slits can be manufactured in any incremental width or length and parallel or non-parallel slits that meet a lab's measuring preferences.

Other features and advantages of the subject disclosure will be readily appreciated, as the same becomes better understood, after reading the subsequent description taken in conjunction with the accompanying drawings.

### BRIEF DESCRIPTION OF THE DRAWINGS

FIG. 1 is top perspective view of a tissue cutting assembly in accordance with an exemplary embodiment of the subject disclosure and a tissue sample with the assembly used for cutting the tissue sample to form tissue samples.

FIG. 2 is an exploded view of FIG. 1.

FIG. 3 is a plan view of a tissue cutting assembly of FIG. 1 including a tissue cutting guide oriented with a plurality of spaced apart open slit guides oriented in a first position.

FIG. 4 is a plan view of the tissue cutting assembly of FIG. 1 with the tissue cutting guide rotated 90 degrees relative to the frame as in FIG. 2 and with the plurality of spaced apart open slit guides oriented in second position.

FIG. 5 is a plan view of a tissue cutting assembly including a hexagonal shaped tissue cutting guide contained within a frame having a hexagonal shaped opening with the tissue cutting guide oriented with a plurality of spaced apart open slit guides oriented in a first position.

FIG. 6 is a plan view of the tissue cutting assembly of FIG. 5 with the tissue cutting guide rotated 60 degrees relative to the frame as in FIG. 5 and with the plurality of spaced apart open slit guides oriented in second position.

FIG. 7 is a plan view of a tissue cutting assembly of FIG. 1 including a tissue cutting guide in accordance with an alternative embodiment wherein the width of the parallel slit guides is decreased as compared to FIG. 3.

FIG. 8 is a plan view of a tissue cutting assembly of FIG. 1 including a tissue cutting guide in accordance with an alternative embodiment wherein a length of each of the plurality of slit guides are not parallel to one another and are distributed in a fan-like configuration.

FIG. 9 is a plan view of a tissue cutting assembly of FIG. 1 including a tissue cutting guide in accordance with an alternative embodiment wherein the length of the parallel slit guides varies.

FIG. 10 is a top perspective view of a tissue sample disposed on a substrate.

FIG. 11 is a top perspective view illustrating a frame being disposed over the tissue sample and substrate of FIG. 10.

FIG. 12 is a close-up top perspective view of FIG. 11 also illustrating a pin used to secure the frame to the substrate.

FIG. 13 is a top perspective view illustrating the positioning of the tissue cutting guide onto the tissue sample of FIGS. 10-12 in a first position.

FIG. 14 is a top perspective view illustrating the introduction of a cutting device through one of the plurality of slits of the tissue cutting guide in FIG. 13 to cut the tissue sample along the length of the one slit.

FIG. 15 is a top perspective view illustrating a user removing the tissue cutting guide of FIG. 13 after performing the cutting steps illustrated in FIG. 14.

FIG. 16 is a top perspective view illustrating the rotating of the tissue cutting guide in rotational direction R₁ from the first position shown in FIGS. 13-15 after removing the tissue cutting guide from within the opening of the frame.

FIG. 17 is a top perspective view illustrating the positioning of the tissue cutting guide in a second position after the rotation of the tissue cutting sample from FIG. 16 onto the tissue sample within the opening of the frame and illustrating the introduction of the cutting device through a second slit of the plurality of slits of the tissue cutting guide to cut the tissue sample along the length of the second slit.

FIG. 18 is a top perspective view illustrating the removal of one cut tissue sample by the user after the removal of the tissue cutting guide as in FIG. 17.

### DESCRIPTION OF THE PREFERRED EMBODIMENT(S)

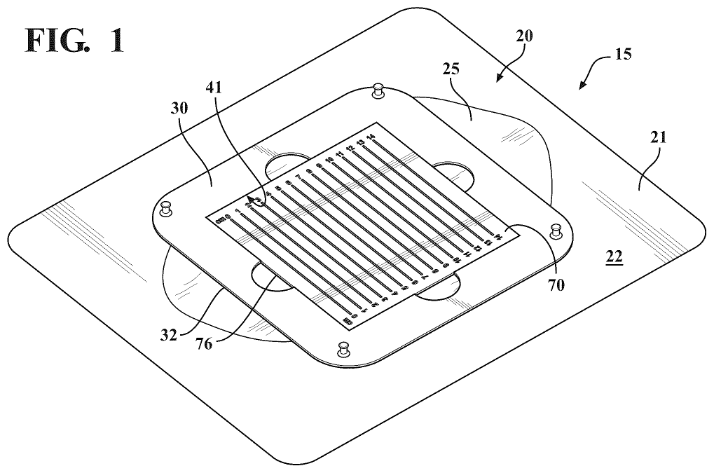

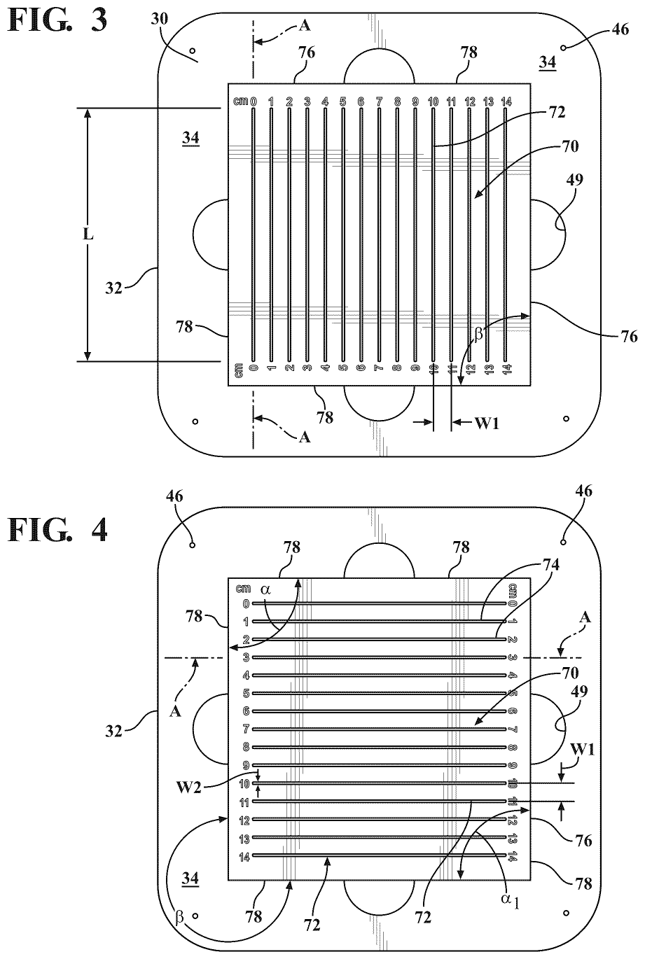

Referring now to FIGS. 1-4, a tissue cutting assembly 15 is provided that includes, as its major components, a substrate 20 configured to receive a tissue sample 25 thereon, a frame 30 secured to the substrate 20 and having internal perimeter 41 defining an opening 50 through which the tissue sample 25 is exposed, and a tissue cutting guide 70 positionable within the opening 50 in at least two distinct positions (a first position and a second position for one embodiment of the tissue cutting guide 70 are illustrated in FIGS. 3 and 4, respectively) or, in certain embodiments, a plurality of distinct positions.

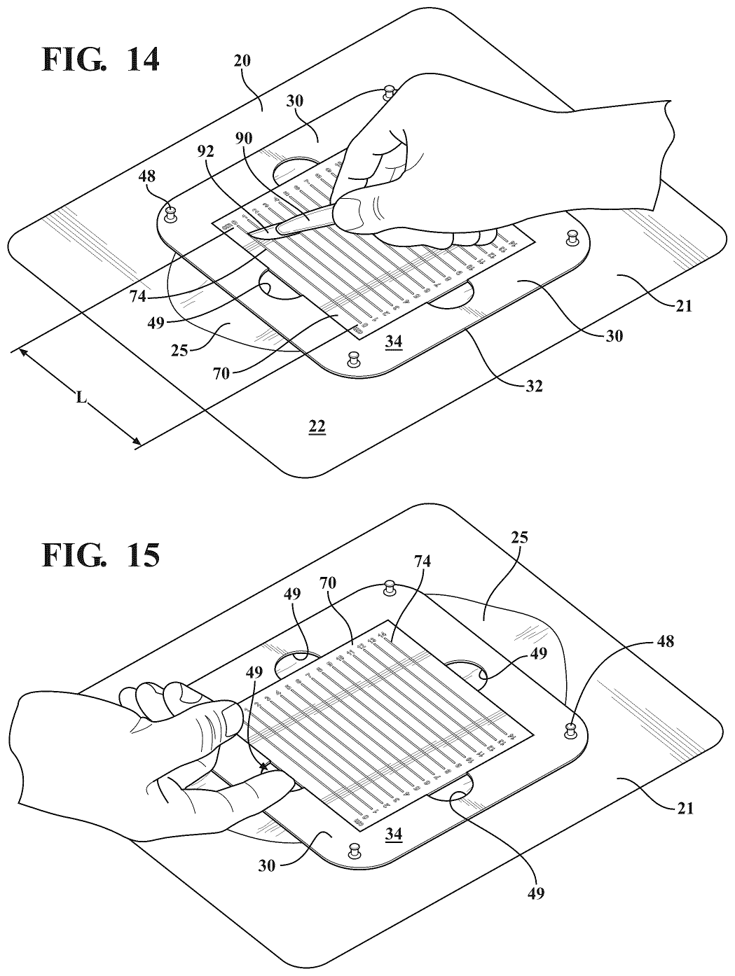

The tissue cutting guide 70 defines one or more cutting slits 74, and preferably a plurality of spaced apart cutting slits 74, through which a user can insert and guide a cutting device 90 (see FIGS. 14 and 17) to cut the tissue sample 25 along a length corresponding to the length of the one or more slits 74 to apply desired cuts to the tissue same and form tissue samples 95 (see FIG. 19) of desired width and lengths or of desired shapes (described further below), hereinafter alternatively referred to as “sized and shaped tissue samples 95”. In each of the respective distinct tissue guide positions of the plurality of positions, the length of one of the respective cutting slits 74 in one position extends transverse to the length of the same one respective cutting slit 74 (for example, as shown in FIGS. 3 and 4, the length of one of the respective cutting slits 74 in the first position extends transverse to length of the same cutting slit 74 in the additional or second position).

The substrate 20 is configured to receive a tissue sample 25 thereupon, and preferably includes a sheet 21 of a cut-resistant material, such as a homogenous sheet 21 of cut-resistant paper material. In certain embodiments, a coating layer 22 of a polymeric material (i.e., a plastic or plastic material) is disposed on a top surface of the sheet 21 that provides a sterile durable surface to prevent liquid absorption of the tissue sample 25 into the substrate 20 and reduces cross contamination between the substrate 20 and the tissue sample 25.

The frame 30 is a structure that is designed to be disposed on the substrate 20 and surround the tissue sample 25. The frame 30 may be of any outer peripheral shape defined by an outer surface 32. Preferably, the frame 30 has a thickness, defined between an upper surface 34 and a lower surface 36.

In the exemplary embodiments, the frame 30 also includes an inner surface 40, which also connects the upper surface 34 and lower surface 36, defining an opening 50 that extends through the upper surface 34 and the lower surface 36, with the tissue sample 25 positioned within the opening 50 and accessible through the opening 50. In particular, the inner surface 40 defines the internal perimeter 41, which defines the opening 50. A partial abutment of an external perimeter 77 of the tissue cutting guide 70 to the internal perimeter 41 of the frame 30 holds the tissue cutting guide 70 stationary against the substrate 20 in at least two distinct positions (hereinafter referred to as a first position and at least one additional position such as a second position) and in certain embodiments in a plurality of distinct positions. This partial abutment of the external perimeter 77 of the tissue cutting guide 70 to the internal perimeter 41 of the frame 30 also prevents the tissue cutting guide 70 from rotating relative to the frame 30 during any number of cutting operations.

In certain embodiments, such as shown in FIGS. 1-18, the inner perimeter 41 forms a regular-polygonal shape, and hence may be considered a regular polygon-shaped inner perimeter 41 defining a regular polygonal-shaped opening 50 through which the tissue sample 25 is exposed.

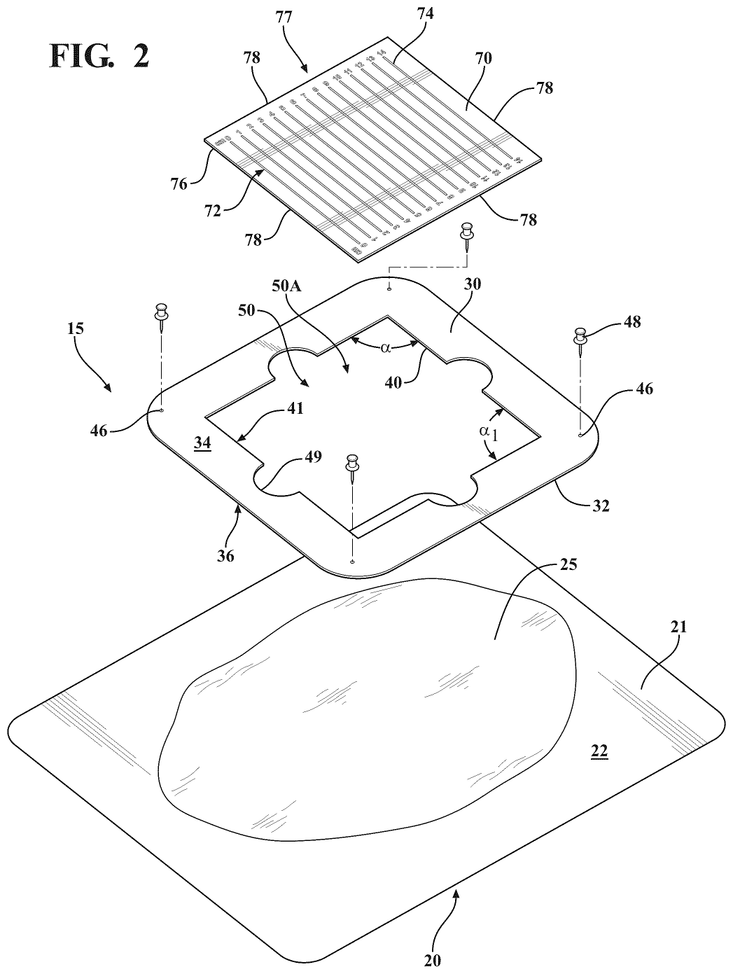

In Euclidean geometry, a regular polygon is a polygon that is equiangular (all angles are equal in measure) and equilateral (all sides have the same length). Accordingly, as defined herein for one of the embodiments, a regular polygon-shaped inner perimeter 41 of the frame 30 that defines the polygonal-shaped opening 50 includes a three or more straight inner surface side portions 52 of equal lengths which are connected to each other, with an adjacent pair of side portions 52 defining an angle α (see FIG. 2) therebetween, with each angle α being equal.

Accordingly, when the regular polygonal-shaped opening 50 defines a triangular-shaped opening (and more precisely an equilateral triangle-shaped opening), there are three surface side portions 52 of equal lengths and the angle α between each two adjacent side portions 52 is sixty (60) degrees that collectively define the triangular-shaped opening 50 (and correspondingly describe a triangular-shaped inner perimeter 41). Similarly, when the polygonal-shaped opening 50 defines a square-shaped opening 50A, such as illustrated in FIGS. 1-4, 7-9, and 11-18, there are four surface side portions 52 of equal lengths and the angle α between each two adjacent side portions 52 is ninety (90) degrees (also shown as angle α1 in FIGS. 2 and 4) between that collectively define the square-shaped opening 50 (and correspondingly describe a square-shaped inner perimeter 41). In yet another example, when the polygonal-shaped opening 50 defines a pentagonal-shaped opening, there are five surface side portions 52 of equal lengths and the angle α between each two adjacent side portions 52 is one-hundred eight (108) degrees that collectively define the pentagonal-shaped opening 50 (and correspondingly describe a pentagonal-shaped inner perimeter 41).

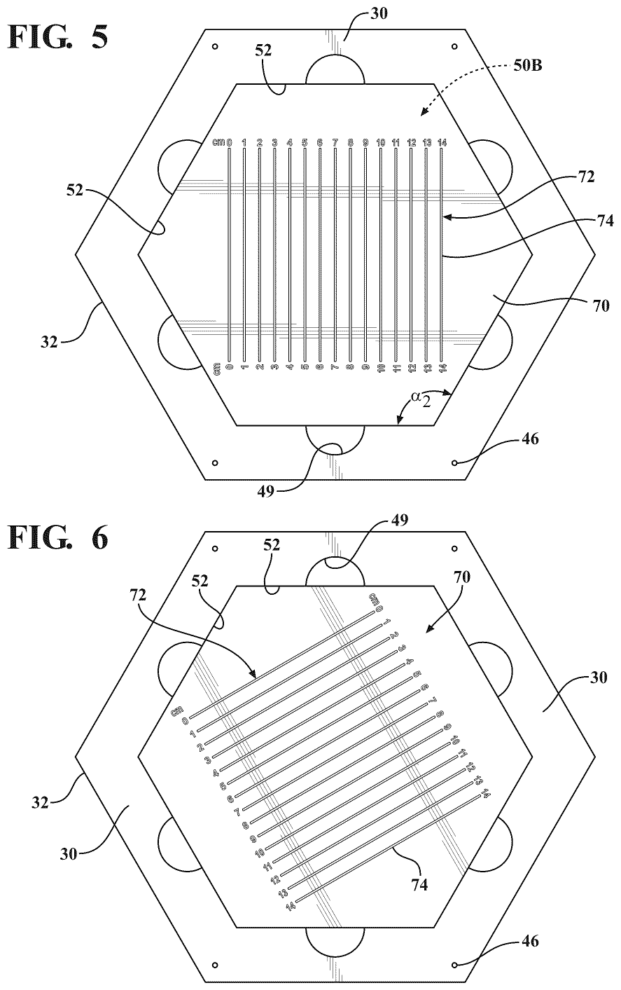

In a still further example, such as shown in FIGS. 5 and 6, when the polygonal-shaped opening 50 defines a hexagonal-shaped opening (shown in phantom as 50B in FIG. 5), there are six surface side portions 52 of equal lengths and the angle α between each two adjacent side portions 52 is one-hundred twenty (120) degrees (also shown as angle α2 in FIG. 5) that collectively define the pentagonal-shaped opening 50 (and correspondingly describe a pentagonal-shaped inner perimeter 41).

In each of these examples, the outer surface 32 of the frame 30 may define a complementary polygonal shape to the inner perimeter 41 defined by the inner surface 40, such as shown in each of FIGS. 1-9 and 11-18. Alternatively, however, the outer surface 32 may define a different polygonal shape to the inner perimeter 41 (such as a square shape where the inner perimeter 41 is hexagonal shape).

Preferably, the frame 30 is formed from a material having sufficient rigidity to maintain its shape during a tissue cutting operation. Even more preferably, the frame 30 is formed from a material that is reusable and can be sterilized prior to use, such as a polymeric material, and in particular a hard and durable plastic material that will not easily be damaged during the cutting process. One exemplary and non-limiting example of a reusable, sterilizable, hard and durable polymeric material suitable for use as the frame 30 is an acrylic material.

In certain embodiments, the frame 30 may include one or more openings 46 (see FIG. 2) defined within the frame material between the outer surface 32 and inner surface 40 that extends through the upper surface 34 and the lower surface 36. Any suitable securing device, such as pins 48, sometimes alternatively referred to as push pins 48, (also shown in FIG. 8) can then be inserted respectively through the openings 46 and within the substrate 20 to secure frame 30 to the substrate 20 to assist in keeping the frame 30 stationary against the substrate 20 during a tissue cutting operation. The pins 48 may be aligned and contained within corresponding openings 22 defined within the substrate 20 when the frame 30 is positioned onto the substrate 20 with the pins 48 assisting in keeping the frame 30 stationary against the substrate 20 during a tissue cutting operation.

In other embodiments, other fastening members such as nails or screws may be used in place of the pins 48 that extend through the openings 46 to secure the frame 30 to the substrate 20. In yet still other embodiments, the pins 48 or other fastening members create the openings 46 when they are driven through the frame 30 and into the substrate material.

In yet other embodiments not shown, as opposed to using pins 48 or fastening members, the frame 30 may include one or more internal pins secured within the material forming the frame 30 and extending outwardly from the lower surface 36 that function in the same manner as the pins 48 to secure the frame 30 to the substrate 20. In particular, the internal pins may be aligned and contained within the corresponding openings 22 of the substrate 20 when the frame 30 is positioned onto the substrate 20 with the internal pins assisting in keeping the frame 30 stationary against the substrate 20 during a tissue cutting operation.

The tissue cutting guide 70 includes an inner surface 72 which defines one or more spaced apart cutting slits 74, and preferably a plurality of equally spaced apart cutting slits 74. The length L of each respective one of the cutting slits 74 defines an axis A (a single axis A corresponding to a single one of the cutting slits 74 is illustrated in each of FIGS. 3 and 4), and in certain embodiments (see for example FIGS. 3-7 and 9) the axis A defined by the length L of each respective cutting slit 74 extends parallel to one another. In alternative embodiments, such as shown in FIG. 8, the lengths L of any two or more of the cutting slits may extend non-parallel to one another.

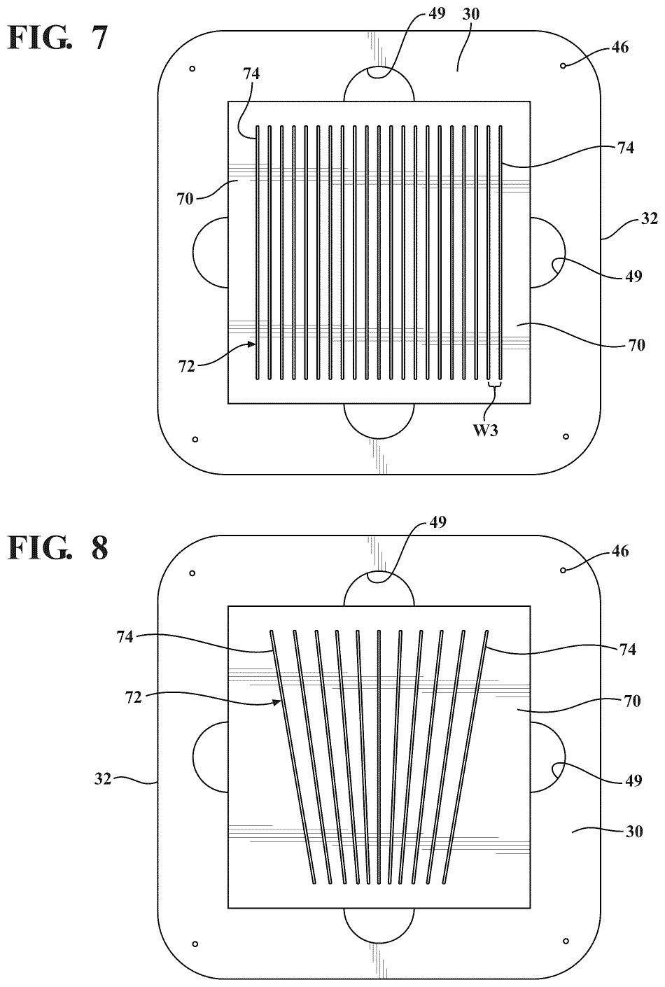

In embodiments in which the axis A of each of the spaced apart cutting slits 74 runs parallel to one another, the spacing between each adjacent pair of the cutting slits 74 defines a width W1 (see for example FIGS. 3 and 4). In the embodiments shown, the width W1 can be spaced in terms of any unit of measurement, including for example millimeters, centimeters or inches. In certain embodiments, such as shown in FIGS. 3-4, the spacing defined as width W1 may larger, while in alternative embodiments, such as shown in FIG. 7, the spacing defined as width W3 may be smaller (i.e., the spacing of the slits 74 defined as width W3 in FIG. 7 is smaller than the spacing of the slits 74 defined as width W1 in FIG. 3). The varying spacing defined as widths W1 or W3 between any two other adjacent slits 74 allows tissue samples 25 having varying sizes to be cut using a single tissue cutting guide 70.

In still further embodiments, a width W2 of a single one, and preferably each single one, of the plurality of slits 74 (also see FIG. 4) is sufficiently wide to allow the width of a blade 92 of a cutting device 90, such as a scalpel, to be introduced therethrough so as to cut the tissue sample 25 along the length L of the cutting slits 74. However, and preferably, the width W2 is only slightly larger than the width of the blade 92 of the cutting device 90, such as in certain embodiments no more than twice the width of the blade 92 of the cutting device 90, to allow the blade 92 of the cutting device 90 to cut through the underlying tissue sample 25 substantially along a straight line corresponding to the length L of the respective slit 74.

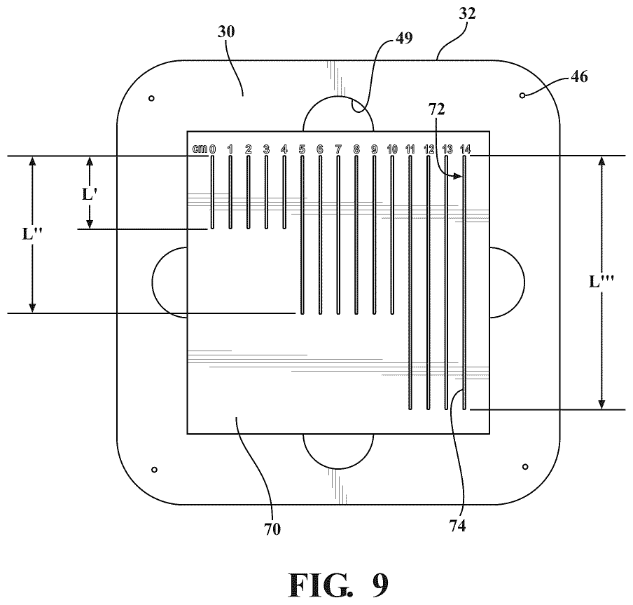

In certain embodiments, such as shown in FIGS. 3-8, the length L of each of the slits 74 is the same. However, in other embodiments such as shown in one representative example in FIG. 9, the length L′ of any one or more of the slits 74 may be different than the length L″ or the length L″′ of any other one or more of the slits 74.

The tissue cutting guide 70 also includes an outer surface 76, with the size and shape of the tissue cutting guide 70 defined by the outer surface 76, with the outer surface also defining an external perimeter 77 (see FIG. 2), being complimentary to the inner surface 40 (and the internal perimeter 41) of the frame 30 such that it can be positioned adjacent to and held stationary within the opening 50 of the frame 30 within the at least two distinct positions as partially described above. In other words, the outer surface 76 or outer perimeter of the tissue cutting guide 70 is positioned adjacent to and within the inner surface 40 or inner perimeter of the frame 30 during any number of tissue cutting operations in each of the at least two positions (i.e., in each of the plurality of positions) with the internal perimeter 41 of the frame 30 complimentary to the external perimeter 77 of the tissue cutting guide 70 in each of the at least two positions, or in each of the plurality of positions.

In certain embodiments, the outer surface 76 of the tissue cutting guide 70 includes a plurality of outer side portions 78 of equal length with the collection of outer side portions 78 defining the external perimeter 77. In addition, each pair of adjacent side portions 78 forms an angle β (see FIG. 4) therebetween, with the angle β of each pair of adjacent side portions 78 being equal such that the outer side portions 78, and external perimeter 77, define a regular polygon, and accordingly the tissue cutting guide 70 may be referred to as regular polygonal-shaped cutting guide 70.

In certain embodiments, the polygonal shape defined by the outer surface side portions 78 of the tissue cutting guide 70 is complimentary to the polygonal shape defined by the inner surface side portions 52 that collectively define the opening 50 in the frame 30, with the lengths of the outer surface side portions 78 of the tissue cutting guide 70 being slightly smaller than the corresponding length of the inner surface side portions 52 of the frame 30. Stated another way, the internal perimeter 41 of the frame 30 is complimentary to the external perimeter 77 of the tissue cutting guide 70 to permit the tissue cutting guide to snugly fit within the opening of the frame thereby eliminating virtually any movement of the tissue cutting guide when positioned within the opening in the frame. In addition, the angle α defined between the adjacent side portions 52 of the frame 30 is equal to 360 degrees minus the angle β defined between the adjacent side portions 78 of the tissue cutting guide 70. Stated another way, in embodiments wherein the polygonal shape defined by the outer surface side portions 78 of the tissue cutting guide 70 is complimentary to the polygonal shape defined by the inner surface side portions 52 that collectively define the opening 50 in the frame 30, the sum of angle α and angle β is 360 degrees. Accordingly, when the tissue cutting guide 70 is positioned within the frame 30 in a first position (see FIGS. 3 and 5 for example) or in any additional position (such as a second position—see FIGS. 4 and 6), the outer surface side portions 78 of the tissue cutting guide 70 are adjacent to and inward of the corresponding inner surface side portions 52 of the frame 30. Accordingly, and as noted above, when the tissue cutting guide 70 is disposed within the opening 50 and on the tissue sample 25 in any one of the plurality of positions, the external perimeter 77 of the tissue cutting guide 70 as least partially abuts the internal perimeter 41 of the frame 30 so as to prevent the rotation of the tissue cutting guide 70 in a clockwise or counterclockwise direction relative to the frame 30.

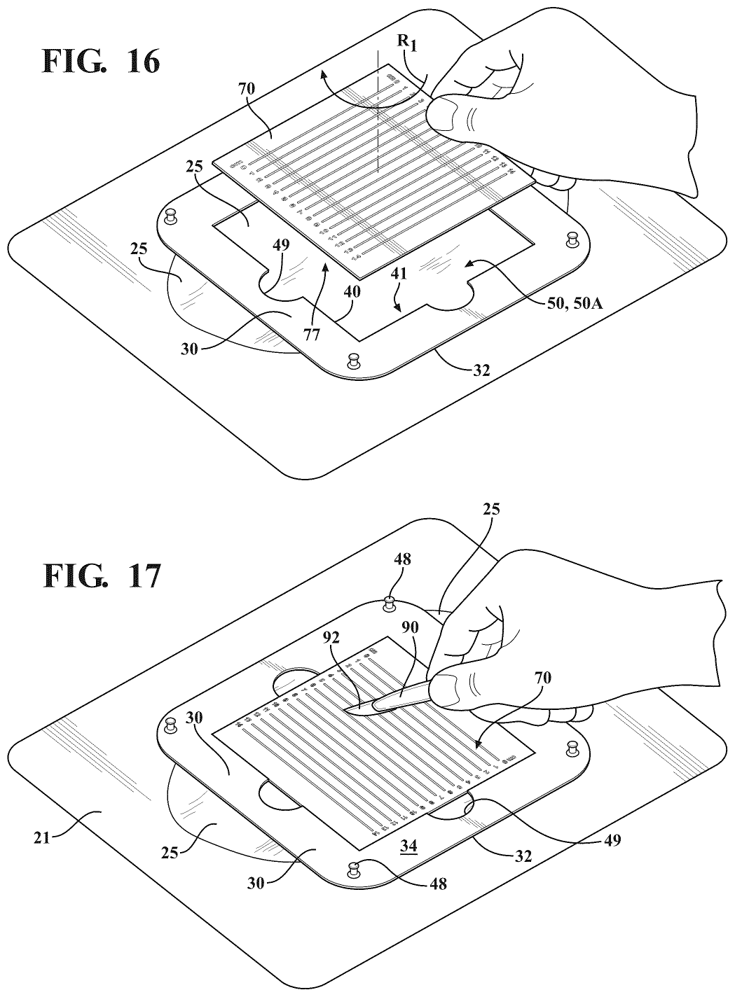

In still further embodiments, and in order to assist a user in moving the tissue guide 70 from a first position to a second position in order to facilitate multiple cutting operations along different directions, the frame 30 may include one or more notches 49 (i.e., finger notches 49-see FIGS. 3 and 16) extending within the upper surface 34 at a position adjacent to and extending from the inner surface 40. As shown, the frame 30 includes at least one notch 49 positioned adjacent to the internal perimeter 41 for allowing a finger of a user to engage the external perimeter 77 of the tissue cutting guide 70 to remove the tissue cutting guide 70 from within the opening 50. Preferably, the frame 30 includes a plurality of notches 49 disposed within the internal perimeter 41 of the frame 30 to allow access to the external perimeter 77 of the tissue cutting guide 70 to facilitate removal of the tissue cutting guide from within the opening of the frame. The notches 49 are sized and shaped with sufficient depth beneath the upper surface to allow a finger of a user to engage the outer surface 76 of the cutting guide 70 to lift the tissue cutting guide 70 from within the opening 50 in the frame 30 in a direction away from the substrate 20. The same tissue cutting guide 70, or another tissue cutting guide 70 having the same external perimeter 77 (as described further below), may then disposed again within the opening 50 onto the tissue sample 25 to allow the user to perform a section cutting operation.

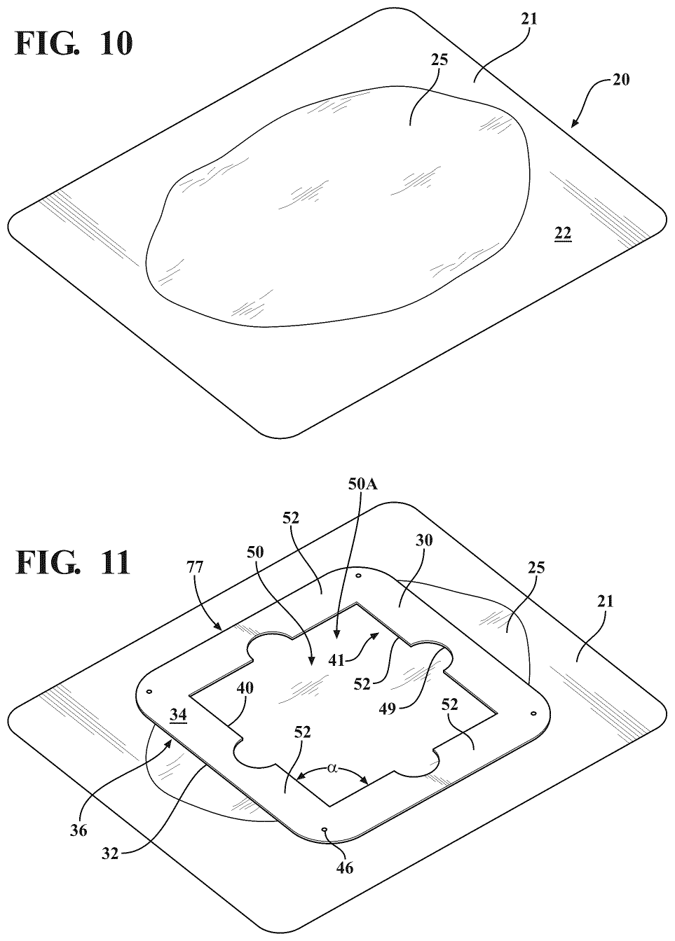

The subject disclosure also provides an associated method of use of the assembly 15 to cut tissue samples 25 to form desired size and shaped tissue samples 95, as illustrated in the corresponding FIGS. 10-18. For ease of description of the method below, the polygonal shape defined by the outer surface side portions 78 and the external perimeter 77 of the tissue cutting guide 70 is square-shaped and complimentary to the polygonal square shape defined by the inner surface side portions 52 and internal perimeter 41 that collectively define the opening 50, 50A in the frame 30, with the lengths of the outer surface side portions 78 of the tissue cutting guide 70 being slightly smaller than the corresponding length of the inner surface side portions 52 of the frame 30.

Referring first to FIG. 10, the method begins by disposing, or otherwise placing or positioning, the tissue sample 25 onto the surface of the substrate 20, such as onto the coating layer 22 of the sheet 21.

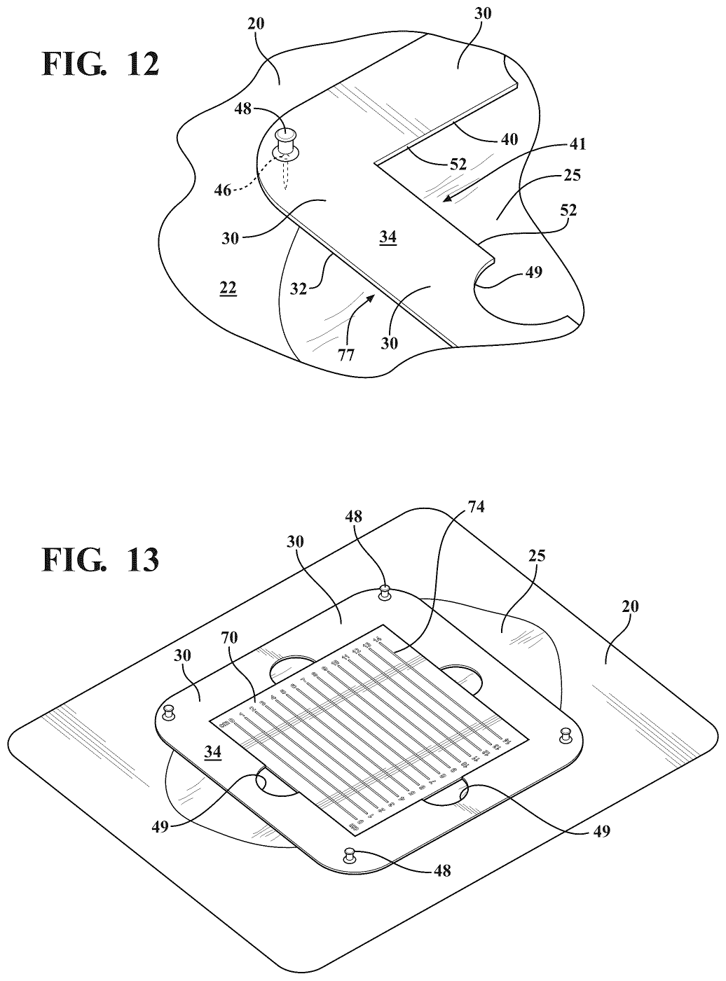

Next, as shown in FIGS. 11 and 12, the frame 30 is disposed onto the substrate 20 with the lower surface 36 adjacent to the upper surface of the substrate 20 (or adjacent to the coating layer 22 of the sheet 21) such that the tissue sample 25 is exposed through the opening 50.

Next, as also shown in FIG. 12, the frame 30 is secured to the substrate 20, such as by introducing pins 48 through the openings 46 in the frame 30 (which are then secured to the substrate 20). In embodiments not including pins 48 or other fastening members or otherwise not securing the frame 30 to the substrate 20, the method proceeds on to FIG. 13.

Next as shown in FIG. 13, the tissue cutting guide 70 is positioned onto the tissue sample 25 within the opening 50, 50A in a first position. The first position is characterized wherein the plurality of slits 74 are aligned relative to a fixed point on the frame 30, the tissue sample 25, or the substrate 20.

For example, the plurality of slits 74 may be aligned in a “north/south” configuration from the user's vantage point, with the “north” configuration referring to an area of the frame 30, the tissue sample 25, or the substrate 20 that is furthest from the user and with the “south” configuration referring to an area of the frame 30, the tissue sample 25, or the substrate 20 that is closest to the user.

Next, in and as illustrated in FIG. 14, a first cut is made through the tissue sample 25 wherein the user inserts the blade 92 of a cutting device 90 within a desired one of the slits 74 and applies pressure in a direction towards the tissue sample 25 while moving the blade 92 of the cutting device along the length L of one of the slits 74 from “north to south” or “south to north”. The process is repeated by inserting the blade 92 of the cutting device 90 within each additional desired one of the slits 74 and applying pressure in a direction towards the tissue sample 25 while moving the blade 92 of the cutting device along the length L of one of the slits 74 from “north to south” or “south to north”. This results in the tissue sample 25 being cut into a first set of cuts of smaller tissue samples separated by a series of “north/south cuts”.

Once the first set of cuts, such as the “north/south” configuration of cuts as described above are made, are made through the slits 74 in the tissue cutting guide 70 and into the tissue sample 25, the process proceeds as illustrated in FIGS. 15-17 where the tissue cutting guide 70 is repositioned in a second position and a second set of cuts are performed. The repositioning preferably includes the steps of removing the tissue cutting guide from within the opening 50 of the frame 30 (FIG. 15) and rotating the tissue cutting guide 70 from the first position a certain predetermined number of degrees in a first rotational direction or second rotational direction (first rotational direction R₁, corresponding to a clockwise rotation, is shown in FIG. 16 to a second position (as shown in FIG. 17)) and reinserted within the opening 50 of the frame 30, with the outer surface 76 of the tissue cutting guide 70 aligned and held in place to prevent rotation in the second position by the inner surface 40 of the frame 30 (i.e., where the complementary internal perimeter 41 and external perimeter 77 prevent rotation of the tissue guide 70 relative to the frame 30). In other words, the tissue cutting guide 70 is repositioned from the first position (i.e., the position as shown in FIG. 15) to the second position (i.e., the position as shown in FIG. 17) different from the first position by rotating the tissue cutting guide 70 in a first rotational direction R₁, or by rotating the tissue cutting guide 70 in a second rotational direction opposite the first rotational direction R₁. For the tissue guide 70 having a square-shaped external perimeter 77, the tissue guide 70 is rotated 90 degrees from the first position (shown in FIG. 15) to the second position and repositioned within the opening 50 of the frame 30, as shown in FIG. 17.

As shown in FIG. 17, a second set of cuts is then made in the tissue sample 25 using the same tissue cutting guide 70 and a cutting device 90 in the same manner described above.

In embodiments wherein the tissue cutting guide 70 is rotated 90 degrees to the second position relative to the first position (such as where the tissue guide 70 has a square-shaped external perimeter 77 and the corresponding frame has a square-shaped internal perimeter 41 and is moved to the second position as shown in FIG. 17), the second set of cuts of the tissue sample 25 made through the slits 74 by the cutting device 90 results in a second set of cuts in the tissue sample orthogonal (i.e., wherein the second set of cuts are made in an “east/west” configuration) as compared to the cuts made in the “north/south configuration in the first position to the first set of cuts to create desired sized and shaped tissue samples 95 (such as the desired rectangular -or square-shaped tissue samples 95 when the first position and second position of a desired width and length that will then be sterile packaged and sent to surgical centers).

In embodiments wherein the tissue cutting guide 70 is rotated less than 90 degrees to the second position relative to the first position (such as where the tissue guide 70 has a hexagonal-shaped external perimeter 77 and the corresponding frame has a hexagonal-shaped internal perimeter 41 as shown in FIGS. 5 and 6 with the first position shown in FIG. 5 and the second position shown in FIG. 6), the second set of cuts of the tissue sample 25 made through the slits 74 by the cutting device 90 results in a second set of cuts in the tissue sample transverse, but not orthogonal, to the first set of cuts to create desired sized and shaped tissue samples 95.

As an alternative to the step of the method as shown in FIG. 17, a second set of cuts may be made in the tissue sample 25 using a different tissue cutting guide 70 and the same or a different cutting device 90 in the same manner described above.

The different tissue cutting guide 70 preferably includes the same dimensions and shape of the outer surface 76, and hence defines the same external perimeter that is complimentary to the inner surface 40 (and the internal perimeter 41) of the frame 30. However, the different tissue cutting guide 70 includes a different configuration of slits 74 than the first tissue cutting guide 70 (such as, for example, the tissue cutting guide 70 of FIG. 7 (with the narrower width w3) or the tissue cutting guide 70 of FIG. 8 (with the non-parallel slits 74)) such that when the different tissue cutting guide 70 is placed in a second position a different second set of cuts are completed with the cutting device 90 as compared with the second set of cuts using the same tissue cutting guide.

Once the second set of cuts are completed, an additional optional step may be performed wherein the tissue cutting guide 70 is removed from the opening 50 and rotated from the second position to a third position distinct and different from the first and second position. In this third position, additional cuts can be made to cut the tissue sample 25 at another angle transverse to the cuts made in each of the first and second position. This optional step can be repeated for as many additional positions as desired, resulting in the tissue sample 25 being cut into any number of sized and shaped tissue samples 95. From a practical standpoint, the number of distinct positions is related to the number of side of the regular polygon that is provided for the frame 30 and the tissue cutting guide 70.

As an alternative the method described above using a single cutting guide, the subject disclosure also provides where a new tissue cutting guide 70, having a different configuration of slits 74, replaces the first tissue cutting guide 70, and the steps of cutting the tissue sample 25 are performed in substantially the same manner as with the original tissue cutting guide 70 utilizing the new tissue cutting guide 70. In this example, the new tissue cutting guide 70 includes has the same external perimeter 77 as the original tissue cutting guide 70, but a different configuration of slits 74. The new tissue cutting guide 70 may be, for example, the tissue cutting guide 70 of FIG. 7 (with the smaller slit spacing defined by W3), the tissue cutting guide 70 of FIG. 8 (with the non-parallel slits 74 such as the fan pattern of slits 74 shown in FIG. 8), or the tissue cutting guide 70 of FIG. 9 (having different length slits 74).

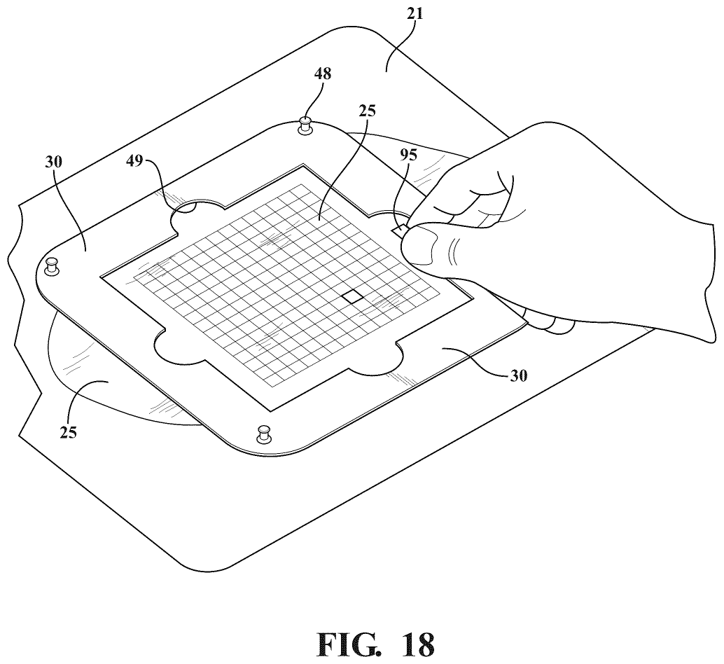

Once the tissue sample 25 has been cut into any number of tissue samples of a desired size and shape, the tissue cutting guide 70 is removed from the opening 50, and the frame 30 is removed from its position on the substrate 20, thereby exposing the desired sized and shaped tissue samples 95 which can be removed by the user in individual steps, as shown in FIG. 18. The desired sized and shaped tissue samples 95 may then be placed into packaging for subsequent use by the user in a manner desired.

The subject disclosure eliminates the need for a straight-edge ruler used to cut tissue samples and allows for a consistent, repeatable method for cutting tissue samples of desired lengths, widths, or shapes. Still further, by providing the tissue cutting guide with an external perimeter complimentary in configuration to the internal perimeter of the frame, and by preventing the rotation of the tissue cutting guide after disposition of the tissue cutting guide within the frame due to the partially abutment of the tissue cutting guide with the internal perimeter of the frame, the elimination or minimization of misshapen tissue samples associated with the movement of the tissue cutting guide during a cutting operation can be achieved, saving time and effort in preparing tissue samples. In addition, the multiple cutting guide slits can be manufactured in any incremental width or length and parallel or non-parallel slits that meet a lab's measuring preferences for producing cut tissue samples in any desired size or shape that is repeatable.

The subject disclosure has been described in an illustrative manner. It is to be understood that the terminology, which has been used, is intended to be in the nature of words of description rather than of limitation.

Many modifications and variations of the subject disclosure are possible in light of the above teachings. Therefore, the subject disclosure may be practiced other than as specifically described.

What is claimed is:

1. A tissue cutting assembly comprising:
a substrate configured to receive a tissue sample thereon;
a frame secured to said substrate having an internal perimeter defining an opening; and
a tissue cutting guide having an external perimeter complimentary in configuration to said internal perimeter of said frame, said tissue cutting guide defining a plurality of spaced apart slits extending therethrough;
wherein said tissue cutting guide is positionable within said opening of said frame in any one of a plurality of positions relative to said frame, and
wherein said external perimeter of said tissue cutting guide at least partially abuts said internal perimeter of said frame to prevent rotational movement of said tissue cutting guide relative to said frame and said substrate once placed in said one position of said plurality of positions for allowing a user to apply desired cuts to the tissue sample through the spaced apart slits.

2. The tissue cutting assembly of claim 1, wherein a length of one of said plurality of spaced apart slits extends transverse to said length of said same one of said plurality of slits when said tissue cutting guide is moved from a first position of said plurality of positions to a second position of said plurality of positions, said second position different than said first position.

3. The tissue cutting assembly of claim 1, wherein said plurality of spaced apart slits are parallel to each other.

4. The tissue cutting assembly of claim 1, wherein a length of said one of said plurality of spaced apart slits extends transverse to a length of at least an other one of said plurality of slits.

5. The tissue cutting assembly of claim 1, wherein one or more of said plurality of slits is not parallel to at least one other one of said plurality of slits.

6. The tissue cutting assembly of claim 1, wherein said inner surface of said frame is a polygonal-shaped inner surface and said outer surface of said tissue cutting guide is a polygonal-shaped outer surface complimentary to said polygonal-shaped inner surface.

7. The tissue cutting assembly of claim 1, wherein said inner surface of said frame is a regular polygonal-shaped inner surface and said outer surface of said tissue cutting guide is a regular polygonal-shaped outer surface complimentary to said regular polygonal-shaped inner surface.

8. The tissue cutting assembly of claim 7,
wherein said inner surface of said frame is a square-shaped inner surface and said outer surface of said tissue cutting guide is a square-shaped outer surface complimentary to said square-shaped inner surface, and
wherein said plurality of positions comprises a first position and a second position different than said first position with said tissue cutting guide rotated 90 degrees and positioned within said opening of said frame in said second position relative to said first position.

9. The tissue cutting assembly of claim 8, wherein said plurality of spaced apart slits are parallel to each other.

10. The tissue cutting assembly of claim 1, wherein said frame includes a notch positioned adjacent to said internal perimeter for allowing a finger of a user to engage said external perimeter of said tissue cutting guide to remove said tissue cutting guide from within said opening.

11. The tissue cutting assembly of claim 1, wherein a width between any two adjacent slits of said plurality of slits is the same.

12. The tissue cutting assembly of claim 1, wherein a width between any two adjacent slits of said plurality of slits is different than a width at least one of pair of adjacent slits of said plurality of slits.

13. The tissue cutting assembly of claim 1, wherein a length of each of said plurality of slits is the same.

14. The tissue cutting assembly of claim 1, wherein a length of said one of said plurality of slits is different than a length of at least one other one of said plurality of slits.

15. The tissue cutting assembly of claim 1, wherein said frame includes a plurality of notches disposed within said internal perimeter of said frame to allow access to said external perimeter of said tissue cutting guide to facilitate removal of said tissue cutting guide from within said opening of said frame.

16. A method of preparing desired sized and shaped tissue samples from a tissue sample using a frame, a tissue cutting guide, and a substrate, the frame having an inner perimeter defining an opening, and the tissue cutting guide having an external perimeter complimentary in configuration to the internal perimeter and defining a plurality of slits extending therethrough, said method comprising the steps of:
disposing the tissue sample on the substrate;
disposing the frame on the substrate such that the tissue sample is held stationary by the frame and such that a portion of the tissue sample is visible and accessible through the opening;
securing the frame to the substrate;
disposing the tissue cutting guide within the opening of the frame in any one of a plurality of positions relative to the frame, wherein the external perimeter of the tissue cutting guide at least partially abuts the internal perimeter of the frame to prevent rotational movement of the tissue cutting guide relative to the frame and the substrate; and
allowing a user to apply desired cuts to the tissue sample through the spaced apart slits.

17. The method of claim 16, wherein said step of allowing a user to apply desired cuts to the tissue sample comprises the steps of:
(a) inserting a blade of a cutting device within one of the slits of the plurality of slits; and
(b) moving the blade of the cutting device along the length of the one slit to cut the tissue sample.

18. The method of claim 17, wherein said step of allowing a user to apply desired cuts to the tissue sample further comprises the steps of:
(c) removing the blade of the cutting device from within the one slit; and
(d) optionally repeating steps (a)-(c) for one or more additional slits of the plurality of slits.

19. The method of claim 17, further comprising the steps of:
removing the tissue cutting guide from within the opening of the frame;
rotating the tissue cutting guide after the tissue cutting guide is removed from the frame;
disposing the tissue cutting guide within the opening of the frame in a second position of the plurality of positions relative to the frame, the second position different than a first position, wherein a length of one of the plurality of slits extends transverse to the length of the same one of the plurality of slits when the tissue cutting guide is moved from the first position to the second position; and
cutting the tissue sample while the tissue cutting guide is in the second position.

20. The method of claim 19, wherein said step of cutting the tissue sample while the tissue cutting guide is in the second position comprises the steps of:
(e) inserting a blade of a cutting device within one of the slits of the plurality of slits; and
(f) moving the blade of the cutting device along the length of the one slit to cut the tissue sample. 21 The method of claim 20, wherein the step of cutting the tissue sample while the tissue cutting guide is in the second position further comprises the steps of:
(g) removing the blade of the cutting device from within the one slit; and
(h) optionally repeating steps (e)-(f) for one or more additional slits of the plurality of slits.
